(19) United States
(12) Patent Application Publication
(10) Pub. No.: US 2025/0095497 A1
(43) Pub. Date: Mar. 20, 2025

(54) INTERACTIVE VISUALIZATION OF PREDICTED INFORMATION ALONG ACTIVE FLIGHT PATH ON NAVIGATION DISPLAYS

(71) Applicant: THE BOEING COMPANY, Arlington, VA (US)

(72) Inventors: Prasad Rao PIRADI, Bengaluru (IN); Ankur KAUSHIK, Bengaluru (IN); Arunkumar THACHUPARA RAJASEKHARAN, Bengaluru (IN)

(21) Appl. No.: 18/467,547

(22) Filed: Sep. 14, 2023

(51) Int. Cl. G08G 5/00

(52) U.S. Cl. CPC G08G 5/21; G08G 5/30

(57) ABSTRACT

The present disclosure provides systems and techniques for dynamically providing a visualization of predicted flight information on a navigation display. An example technique includes presenting a window comprising a plurality of flight parameters on the navigation display. An indication of at least one first flight parameter selected from the plurality of flight parameters is obtained. A first position associated with the flight plan that is selected on the navigation display is detected. In response to the detection, a first value of the at least one first flight parameter at the first position is predicted and displayed on the navigation display.

### FIELD

Aspects of the present disclosure relate to navigation displays, and more specifically, to methods and systems for dynamically providing an interactive visualization of flight information to navigation displays.

### BACKGROUND

Pilots (flight crew) of modern commercial aircraft operate increasingly complex aircraft in an increasingly complex airspace environment. In executing their flying duties, pilots utilize not only their flying skills but must also manage myriad information related to their flight as efficiently as possible. Generally, the management of information related to the flight entails utilizing a number of means for acquiring, utilizing, and redirecting graphical, aural, and textual information to and from the airplane's systems. For example, such means may include a number of cockpit (flight deck) displays, control panels, keyboard devices, cursor control devices, and voice/audio systems. However, as many of these devices are used for multiple, and sometimes coupled or associated functions, aircraft engineers and pilots are respectively challenged with (a) the task of designing an optimal configuration that simplifies the pilots' task of managing all aspects of their airplane's flight and (b) the task of efficiently flying the airplane utilizing the available flight deck tools.

As such, flight deck displays such as Navigation Displays (NDs) and Multifunction Displays (MFDs) may be used with a Flight Management Computer (FMC) and the Mode Control Panel (MCP) to plan and manage an airplane's flight path and performance from takeoff to landing. Feedback as to the performance of the airplane in relation to the pilots' commands may be available in a number of locations in the cockpit, and sometimes across multiple pages, including NDs, MFDs, Primary Flight Displays (PFDs), MCPs, Control Display Units (CDUs), and Crew Alerting Displays.

The task of optimizing the pilot's interaction and feedback from the airplane's systems presents a multifaceted challenge for both aircraft design engineers and pilots. One example challenge is providing multiple methods of accessing flight management information as such information may be available in multiple display pages and formats so as to simplify the pilots' tasks. Another challenge is related to quick access of flight information, thus reducing head-down time in the cockpit. Another challenge is consistency of the flight management interface over multiple functions so as to increase pilot familiarity, increase proficiency, reduce the need for recall, and reduce the need for retraining. Yet another challenge is the display of certain information or availability thereof without, for example, obstructing, obscuring, or otherwise impeding access to other information.

### SUMMARY

One embodiment of the present disclosure is a computer-implemented method for dynamically presenting a visualization of flight information on a navigation display. The computer-implemented method includes presenting a window comprising a plurality of flight parameters on the navigation display. The computer-implemented method also includes obtaining an indication of at least one first flight parameter selected from the plurality of flight parameters. The computer-implemented method further includes, upon detecting a first position selected on the navigation display associated with a flight plan: predicting a first value of the at least one first flight parameter at the first position; and displaying the first value for the at least one first flight parameter on the navigation display.

Another embodiment of the present disclosure is a flight management system. The flight management system includes a navigation display, a memory including executable instructions, and a processor in data communication with the memory and the navigation display. The navigation display is configured to display information associated with a flight plan of an aircraft. The processor is configured to execute the executable instructions to perform an operation. The operation includes presenting a window comprising a plurality of flight parameters on the navigation display. The operation also includes obtaining an indication of at least one first flight parameter selected from the plurality of flight parameters. The operation further includes, upon detecting a first position selected on the navigation display associated with the flight plan: predicting a first value of the at least one first flight parameter at the first position; and displaying the first value for the at least one first flight parameter on the navigation display.

Another embodiment of the present disclosure is a computer-readable storage medium. The computer-readable storage medium includes computer-readable program code embodied therewith for performing an operation for dynamically presenting a visualization of flight information on a navigation display. The operation includes presenting a window comprising a plurality of flight parameters on the navigation display. The operation also includes obtaining an indication of at least one first flight parameter selected from the plurality of flight parameters. The operation further includes upon detecting a first position selected on the navigation display associated with a flight plan: predicting a first value of the at least one first flight parameter at the first position; and displaying the first value for the at least one first flight parameter on the navigation display.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 illustrates one or more components of an example aircraft systems architecture, in accordance with certain aspects of the present disclosure.

FIG. 2 is a flowchart of an example method for providing a visualization of information on a navigation display, in accordance with certain aspects of the present disclosure.

FIGS. 3A-3C illustrate example visualizations of a navigation display, in accordance with certain aspects of the present disclosure.

FIG. 4 is a flowchart of an example method for displaying information on a navigation display, in accordance with certain aspects of the present disclosure.

FIGS. 5A-5G illustrate example visualizations of a navigation display, in accordance with certain aspects of the present disclosure.

### DETAILED DESCRIPTION

Today, flight management systems (FMSs) compute a predicted four-dimensional (4D) flight profile (both lateral and vertical) of aircraft within specified flight plan constraints and aircraft performance limitations. For example, predicted flight parameters, such as the predicted fuel, time, distance, altitude, and speed, as illustrative, non-limiting examples, are obtained for each position in the flight plan. These positions can include waypoints as well as inserted vertical breakpoints, such as speed change, cross-over, level off, Top of Climb (TOC), and Top of Descent (TOD) points. At present, a significant portion of the flight profile, flight plan, and flight path information predicted by the FMS lacks intuitive presentation or accessibility from a single screen. This is due, in part, to the scattered distribution of FMS data across different pages. Consequently, with current FMSs, it can take considerable pilot effort and prior knowledge to browse through multiple different pages to obtain the predicted data from the Multi-Function Control and Display Unit (MCDU). Furthermore, if the pilots have not used the FMS for a long period of time, it can be hard for the pilots to remember where to look for predicted information, meaning pilots may have to spend a significant amount of time to find the correct FMS page. Such a scenario is not ideal during flight-time, when pilots may need critical information quickly.

As a reference example of such scattered information, consider that a Navigation Display (ND) and a Vertical Situational Display (VSD) generally provide information that is mutually exclusive. For example, while the TOD symbol may be displayed on the ND as well as on the VSD, the TOD altitude may be seen solely on the VSD. As another example, the exact lateral distance may be displayed on the ND, but not on the VSD. As yet another example, in order to determine the estimated time of arrival (ETA) for TOD, the pilot has to browse to the respective FMS page that displays ETA information for TOD. Similarly, other predicted aircraft state information (or more generally flight information), such as speed, distance, altitude, and fuel remaining may be available in different FMS pages. In many cases, the pilot has to have prior knowledge of the relevant FMS page location in order to obtain the desired aircraft state information quickly.

To address the above challenges, certain aspects described herein provide systems, methods, and apparatus for dynamically providing an interactive visualization of predicted flight information on a ND. More specifically, certain aspects provide a system that displays customized predicted information, based on pilot selection, on a navigation display (e.g., within an aircraft cockpit). The system can compute and display the predicted values for the customized parameters for any upcoming portion of the flight plan, based on prior and/or real-time status information of the aircraft. The system described herein enables a user (e.g., pilot or crew member) to review and/or analyze the predicted values (and anticipated fluctuations thereof) for the customized operating parameters during operation of the aircraft in a manner that improves the situational awareness of the flight profile and saves crew time.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12.”

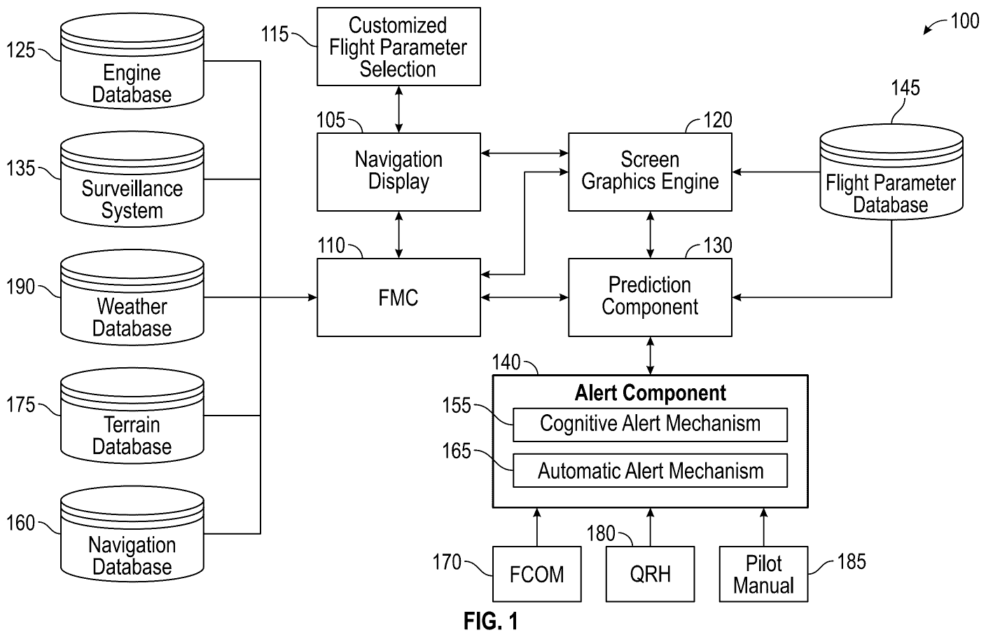

FIG. 1 is a block diagram of an example aircraft systems architecture 100 used for a flight management system (FMS), according to certain aspects of the present disclosure. The aircraft systems architecture 100 includes one or more components that can be used to manage various aspects of an aircraft's flight. Note that FIG. 1 has been simplified in order to make it easier to understand the present disclosure. Those skilled in the art will appreciate that FIG. 1 is one configuration of many that can be implemented for certain aspects of a FMS. For example, the aircraft systems architecture 100 can be hosted on a number of on-board computers suitable for an airplane cockpit graphical display system, which may include, without limitation, a PFD, a Heads-Up Display (HUD), a ND, a MFD, an Electronic Flight Bag (EFB) display, or other displays in the flight deck.

Referring to FIG. 1, the aircraft systems architecture 100 includes, without limitation, a FMC 110, a ND 105, a screen graphics engine 120, a prediction component 130, and an alert component 140, each of which may include hardware, software, or combinations thereof. In certain aspects, the FMC 110 is representative of a computing system, which may include, for example, processor(s), memory, storage, or a combination thereof. The FMC 110 is coupled to an engine database 125, a surveillance system 135, a weather database 190, a terrain database 175, and a navigation database 160.

The engine database 125 includes one or more engine-related parameters, such as engine operating manuals and technical specifications (e.g., engine type, power ratings, design, dimensions, weight, etc.), as illustrative, non-limiting examples. The surveillance system 135 is generally representative of technology that broadcasts information about the aircraft, such as identification, current position, altitude and velocity, and that allows pilots to view traffic information (e.g., altitude, heading, speed, and distance) about surrounding aircraft. One reference example of a surveillance system 135 is an Automatic Dependent Surveillance-Broadcast (ADS-B). The weather database 190 includes information about weather and climate of different geographical regions. The information within the weather database 190 can include weather-related parameters, such as minimum/maximum temperature, precipitation, humidity, and wind speed, as illustrative, non-limiting examples. The terrain database 175 generally includes elevation data, which represents the topography of the earth. The navigation database 160 generally includes information regarding locations, routes, airspace segments, airports, air traffic control (ATC) frequencies, runways, and special use airspace, as illustrative, non-limiting examples.

The FMC 110 can determine a flight plan for the flight using information obtained from the engine database 125, surveillance system 135, weather database 190, terrain database 175, navigation database 160, or a combination thereof. The flight plan may be displayed on the ND 105. As part of the flight plan, the FMC 110 can display a visual indication of the flight plan data, lateral guidance buffers, vertical guidance buffers, performance parameters, or a combination thereof.

The ND 105 is an example display instrument that plots configurable information for various flight parameters, such as speed, heading, flight plan, terrain, weather, and distances, as illustrative, non-limiting examples. The ND 105 may provide different view modes, including, for example, a “PLAN” view mode that provides a 360-degree view for stepping through a current flight plan, and a “MAP” view mode that displays information based on the current position of the aircraft.

In certain aspects, the ND 105 is a touch screen display that can accept user input via the user's touch. In such aspects, the FMC 110 may use the screen graphics engine 120 to control functionality of the ND 105 in response to user interaction in the form of hand gestures, fingertip movements, and other user input. For example, the screen graphics engine 120 may provide touch screen control, annotation capability, and other functions. Note, although not shown, in certain aspects, the ND 105 may be coupled to and directly controlled via the screen graphics engine 120.

As noted, certain aspects described herein provide techniques for providing an interactive visualization of predicted flight information on the ND 105, based on pilot interaction with the ND 105. In certain aspects, a user (e.g., pilot or crew member) may use the ND 105 to input or select a set of customized flight parameters (referred to herein as customized flight parameter selection 115) to monitor as part of the flight plan. The customized flight parameter selection 115 includes a set of flight parameters that can be customized based on the pilot's needs, aircraft's needs, or a combination thereof. Such flight parameters may be stored in and retrieved from the flight parameter database 145. Examples of flight parameters can include, but are not limited to, altitude types, speed constraints, time constraints, predicted anomalies, lateral flight plan deviations, vertical navigation mode changes, fuel computations, thrust management, forecasted information, atmospheric model(s), and traffic information. The FMC 110 can determine predicted values for the customized flight parameter selection 115 and display the predicted values on the ND 105 in an interactive manner (e.g., based on the pilot's interaction with the ND 105).

In certain aspects, the pilot can choose the customized flight parameter selection 115 based on the flight phase or particular scenario. Once selected, the FMC 110 can use the prediction component 130 automatically predict values for each of the flight parameters in the customized flight parameter selection 115 for each position or point in the flight plan. For example, the prediction component 130 can use interpolation, extrapolation, flight plan models, or a combination thereof, along with prior and/or real-time status information of the aircraft, to compute predicted information for the customized flight parameter selection 115.

In certain aspects, the FMC 110 (via the screen graphics engine 120) can detect when the user selects a particular position (e.g., waypoint, between waypoints, or other point) on the active flight plan on the ND 105. Upon detection of a selected position, the FMC 110 (via the prediction component 130) can obtain the predicted information associated with the customized flight parameter selection 115 at the selected position and can display the predicted information (corresponding to the customized flight parameter selection 115) on the ND 105.

In certain aspects, the alert component 140 may provide the prediction component 130 with one or more alert indications associated with the predicted information for the customized flight parameter selection 115. The alert component 140 may determine to indicate an alert, based on information from the Flight Crew Operations Manual (FCOM) 170, Quick Reference Manual (QRH) 180, the Pilot Manual (PM) 185, or a combination thereof. For example, in general, the alert component 140 can indicate when a predicted value for a given flight parameter is invalid, discrepant, out of range, or associated with a hazardous situation. The alert component 140 includes a cognitive alert mechanism 155 and an automatic alert mechanism 165, each of which may include hardware, software, or combinations thereof.

In certain aspects, the cognitive alert mechanism 155 provides, to the prediction component 130, at least one of (i) an indication of when the predicted information for a selected flight parameter(s) is beyond a boundary/buffet limit associated with that flight parameter(s) or (ii) an indication of when the predicted information for a selected flight parameter(s) is at the boundary/buffet limit associated with that flight parameter(s). In such aspects, the FMC 110 (based on an indication received from the prediction component 130) can modify the display of the predicted information on the ND 105 to indicate the alert(s) from the cognitive alert mechanism 155. For example, assuming the parameter “FUEL REMAINING” is selected, the FMC 110 (via the screen graphics engine 120) can display the predicted amount of fuel remaining on the ND 105 at any selected waypoint along the flight plan. In addition to displaying the predicted amount of fuel remaining, the FMC 110 (via the screen graphics engine 120) can provide at least one of (i) an indication of when the predicted amount of fuel remaining is beyond a boundary/buffet limit or (ii) an indication of when the predicated amount of fuel remaining is at the boundary/buffer limit.

In certain aspects, the automatic alert mechanism 165 provides, to the prediction component 130, with one or more alerts associated with hazardous situations. For example, the automatic alert mechanism 165 can provide an indication of (i) a hazardous situation, if not avoided, can result in serious impact, (ii) a hazardous situation, if not avoided, can result in minor or moderate impact, (iii) a cue to raise attention, or (iv) a combination thereof. In such aspects, the FMC 110 (based on an indication received from the prediction component 130) can modify the display of the ND 105 to indicate the alerts from the automatic alert mechanism 165. For example, the FMC 110 can display instinctive signs to indicate a warning, caution, or an alert based on the type of situation.

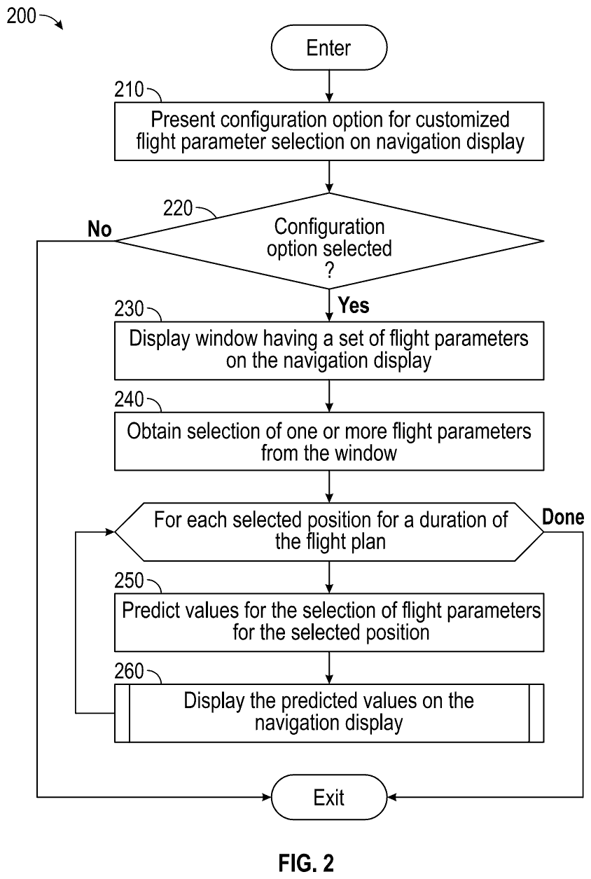

FIG. 2 is a flowchart of an example method 200 for providing a visualization of information on a navigation display, in accordance with certain aspects of the present disclosure. Method 200 may be performed by one or more components of a FMS (e.g., aircraft systems architecture 100).

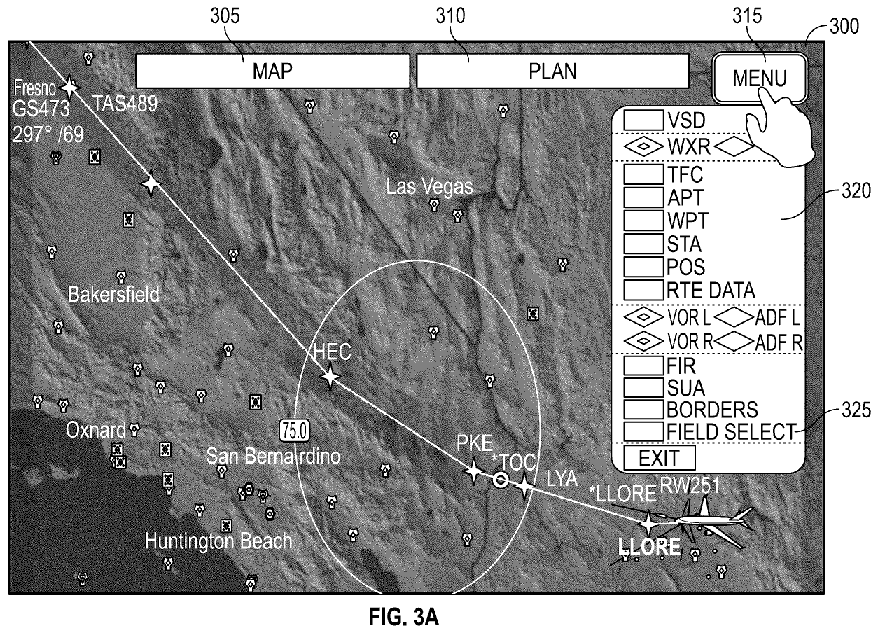

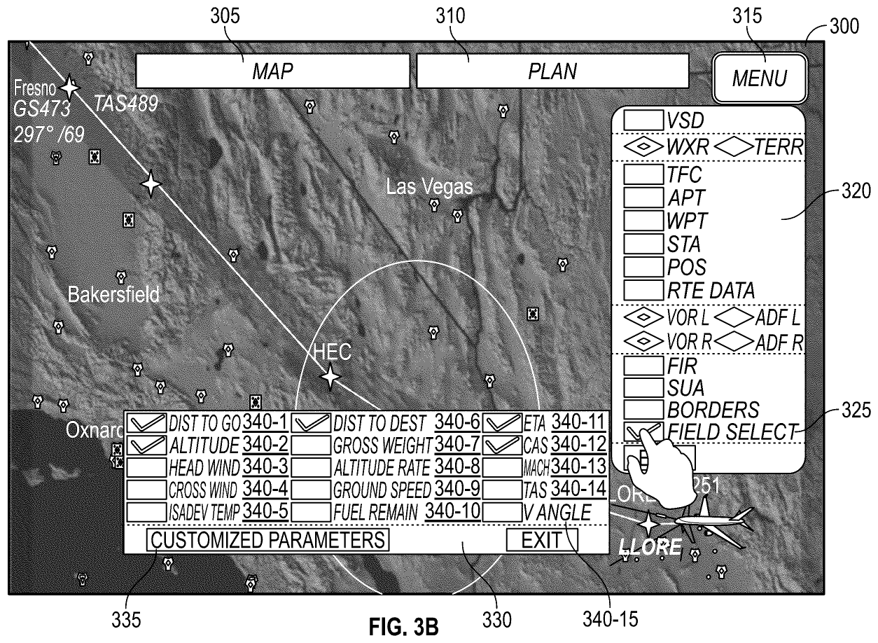

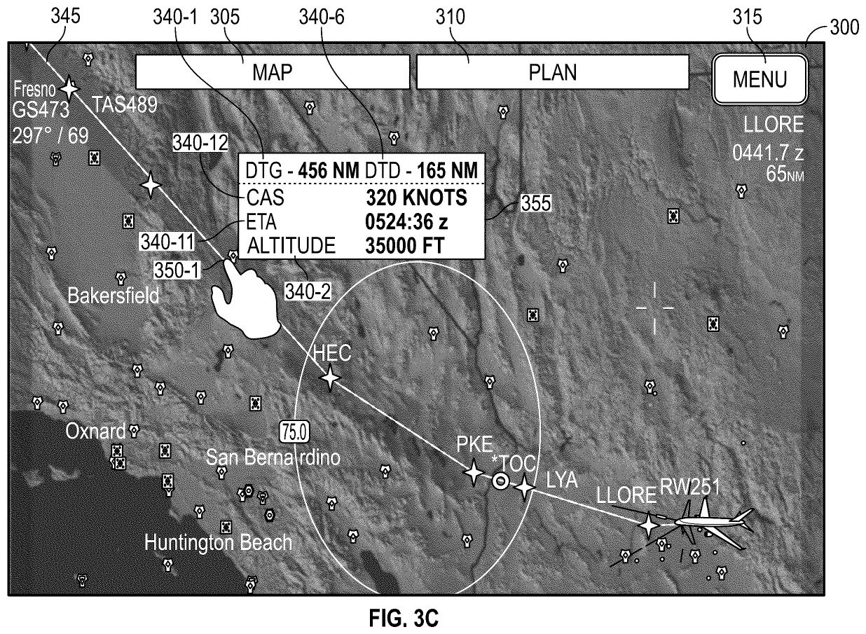

Method 200 may enter at block 210, where the FMS presents a configuration option on the ND 105 that allows the user to select a set of customized flight parameters. As a reference example, FIG. 3A illustrates an example ND 300, which is one implementation of the ND 105 illustrated in FIG. 1, according to certain aspects of the present disclosure. In this example, the ND 300 includes an element 305 that allows the user to select a “MAP” view mode and an element 310 that allows the user to select a “PLAN” view mode. The ND 300 also includes an element 315 (“MENU”) that allows the user to view a window 320 having a set of configuration options for the ND 300.

As shown in FIG. 3A, in certain aspects, a field 325 (“FIELD SELECT”) is added to the window 320 when the element 315 is selected by the user. In certain aspects, the field 325 may be visible when an operational program configuration (OPC) option is enabled based on the airliner's operations.

Referring back to FIG. 2, at block 220, the FMS determines whether the configuration option (e.g., field 325) has been selected. If not, the method 200 may exit. On the other hand, if the configuration option has been selected, then the FMS displays a window with a set of flight parameters on the ND 105 (block 230). As shown in FIG. 3B, for example, when the field 325 (“FIELD SELECT”) is selected from the window 320, the window 330 is displayed on the ND 300. The window 330 includes a set of flight parameters 340 1-15. Here, for example, the set of flight parameters 340 includes “Distance to Go (DIST TO GO)” 340-1, Predicted Altitude (“ALTITUDE”) 340-2, “HEAD WIND” 340-3, “CROSS WIND” 340-4, International Standard Atmosphere (ISA) Deviation of temperature (“ISADEV TEMP”) 340-5, Distance to Destination (“DIST TO DEST”) 340-6, Predicted Gross Weight (“GROSS WEIGHT”) 340-7, Altitude climb/descent rate (“ALTITUDE RATE”) 340-8, “GROUND SPEED” 340-9, Fuel Remaining (“FUEL REMAIN”) 340-10, Estimated Time of Arrival (“ETA”) 340-11, Calibrated Air Speed (“CAS”) 340-12, “MACH” 340-13, True Air Speed (“TAS”) 340-14, and Vertical Angle (“V ANGLE”) 340-15. The window 330 also includes an element 335 “CUSTOMIZED PARAMETERS” that allows the user to see an expanded set of flight parameters 340.

At block 240, the FMS obtains a selection of one or more flight parameters from the window (e.g., window 330). In certain aspects, the user can select one or more of the flight parameters 340 to monitor during the flight plan. For example, the user may select different flight parameters, based on the type of flight, particular flight phase, or scenario. With brief reference to the ND 300 depicted in FIG. 3B, the user may select flight parameters 340-1, 340-2, 340-6, 340-11, and 340-12.

At block 250, the FMS predicts values for the selection of flight parameters for the selected position of the flight plan on the ND 105. At block 260, the FMS displays the predicted values on the ND 105. Note that blocks 250 and 260 may be performed for each selected position in the flight plan for a duration of the flight plan. For example, upon any selection on the active flight plan through the cursor/touchscreen, the ND 105 can send the latitude/longitude values on the selected position to the FMC 110. The FMC 110 can then use the prediction component 130 to process the selected flight parameter(s) at the selected position on the active flight plan. Based on the information available through the engine database 125, surveillance system 135, weather database 190, terrain database 175, navigation database 160, flight parameter database 145, and combinations thereof, the FMC 110 can compute the predicted values by interpolating/extrapolating the information. For example, if the selected position is in between any two waypoints on the active flight plan, the FMC 110 can interpolate/extrapolate the information for the two waypoints to obtain the predicted values for the selected position. Once the predicted values are computed, the predicted values can be displayed on the ND 105.

In one reference example shown in FIG. 3C, the user may select position 350-1 along the flight plan 345 on the ND 300. Once the position 350-1 is selected, the FMS displays the window 355 on the ND 105. The window 355 includes predicted values for each of the selected set of flight parameters (e.g., flight parameters 340-1, 340-2, 340-6, 340-11, and 340-12) at the selected position 350-1. Note that the user can choose any location on the active flight plan to get the predicted flight parameters to display on the ND 300. For example, the selected position 350 can be anywhere on the active/provisional flight plan 345, including the waypoints, between the waypoints, on the HOLD legs, on the profile points, on the lateral offset paths, and on the curved paths, as illustrative, non-limiting examples. In certain aspects, the FMS may always display flight parameters 340-1 and 340-6 so that the user can visualize the actual selected position from the current position, and the remaining flight parameters 340-2, 340-11, and 340-12 may be displayed at the pilot selected position.

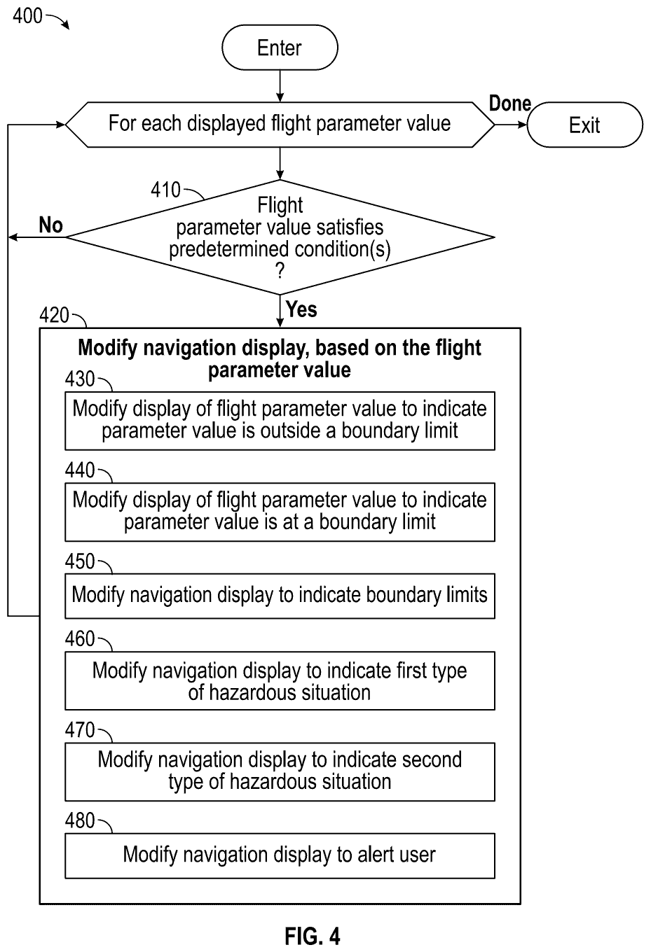

FIG. 4 is a flowchart of an example method 400 for providing a visualization of information on a navigation display, in accordance with certain aspects of the present disclosure. Method 400 may be performed by one or more components of a FMS (e.g., aircraft systems architecture 100). In certain aspects, blocks 410 and 420 of method 400 are performed for each displayed flight parameter value.

At block 410, the FMS determines whether the flight parameter value satisfies a predetermined condition(s). In one aspect, the predetermined condition includes the predicted value for the flight parameter being beyond the boundary/buffet limit associated with the flight parameter. In one aspect, the predetermined condition includes the predicted value for the flight parameter being at the boundary/buffet limit associated with the flight parameter. In one aspect, the predetermined condition includes the flight parameter having a predicted value associated with a first type of hazardous situation. In one aspect, the predetermined condition includes the flight parameter having a predicted value associated with a second type of hazardous situation.

At block 420, the FMS modifies the ND, based on the flight parameter value. In certain aspects, the FMS may modify the ND by modifying attributes (e.g., color, shading, size, highlighting, grayscale, blinking, and other attributes) of the displayed flight parameter value on the ND, based on the predetermined condition. For example, the FMS can modify attributes of the displayed flight parameter value to indicate that the flight parameter value satisfies the predetermined condition. In certain aspects, the FMS may modify the ND by displaying symbols to indicate different types of hazardous situations and/or to raise attention. Block 420 may include one or more of (or a combination of) sub-blocks 430, 440, 450, 460, 470, and 480.

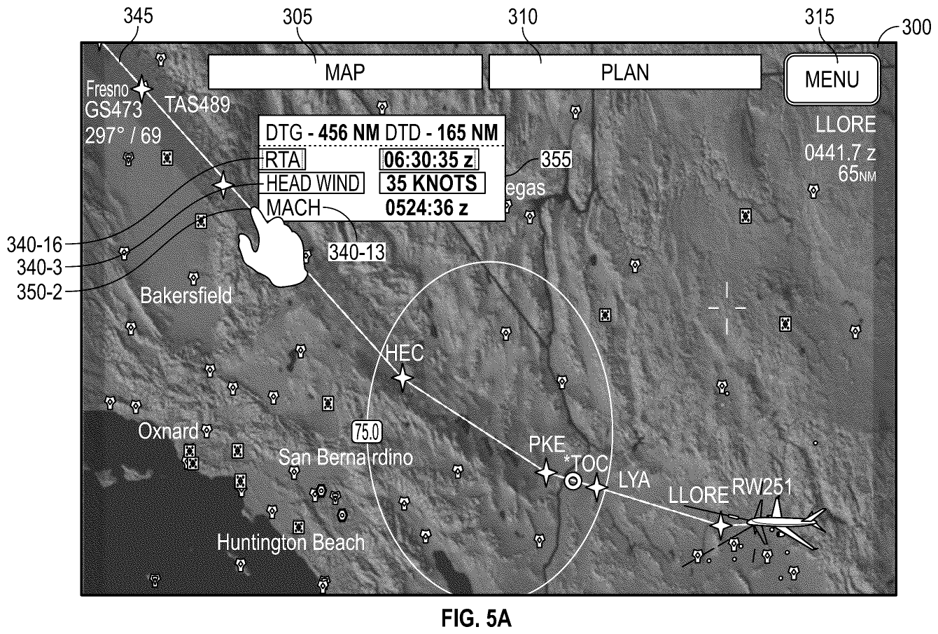

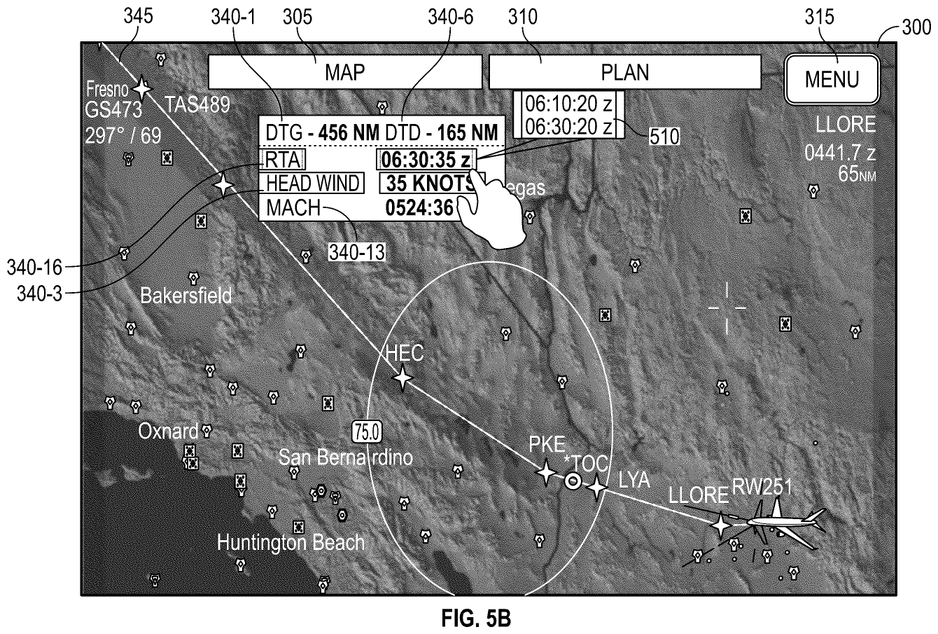

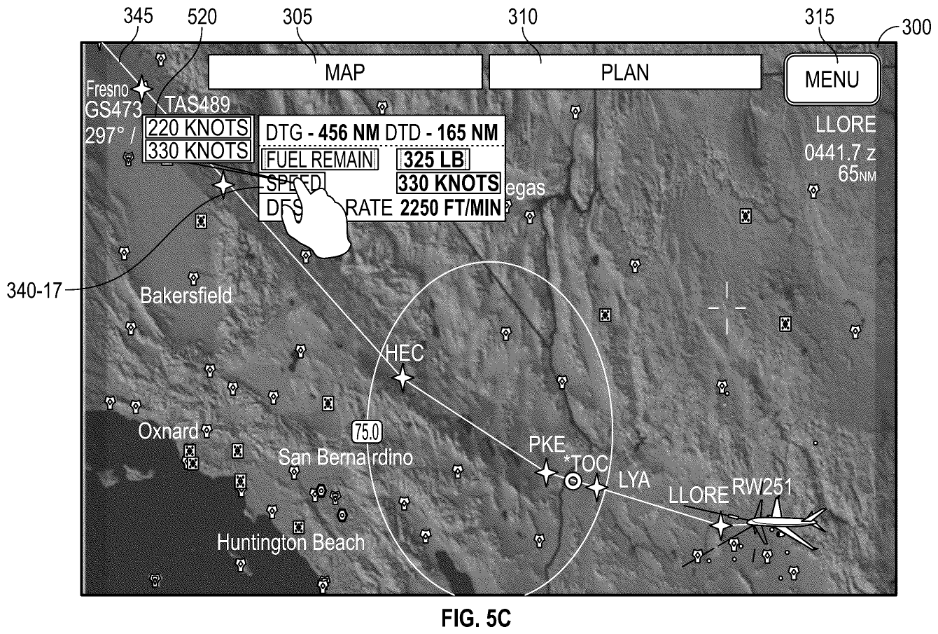

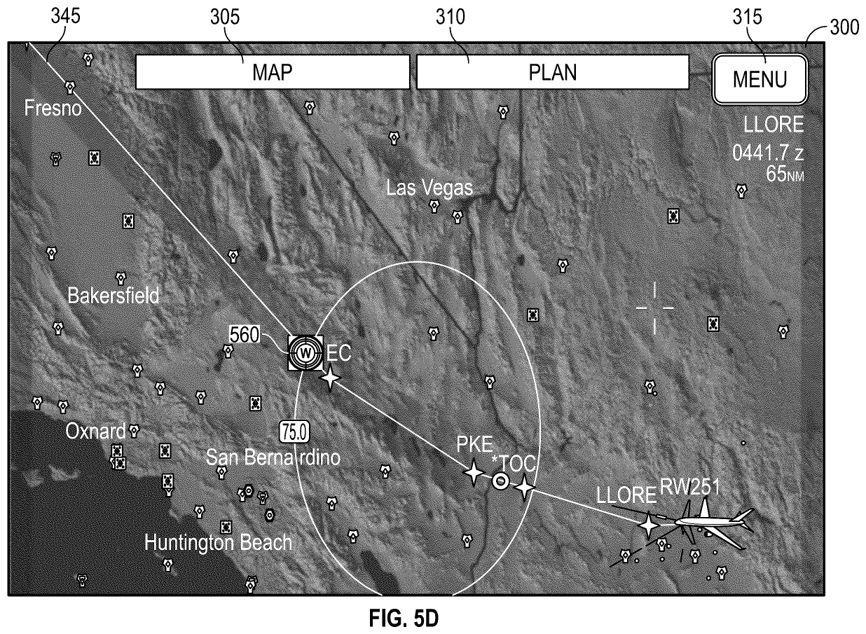

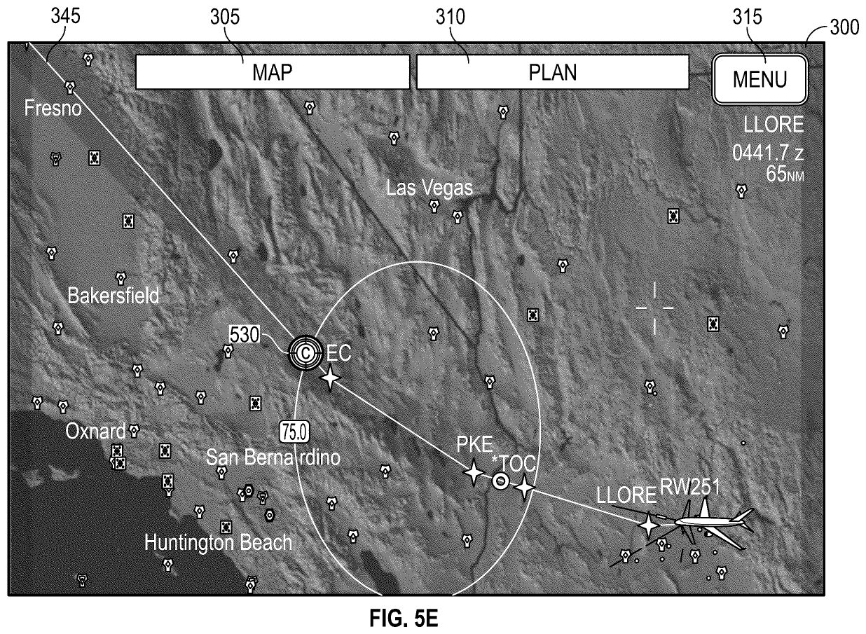

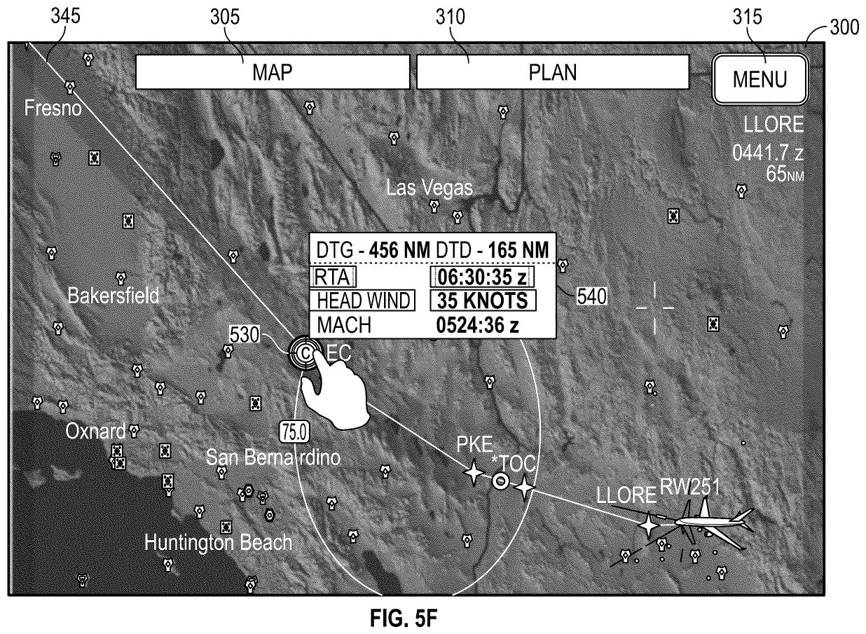

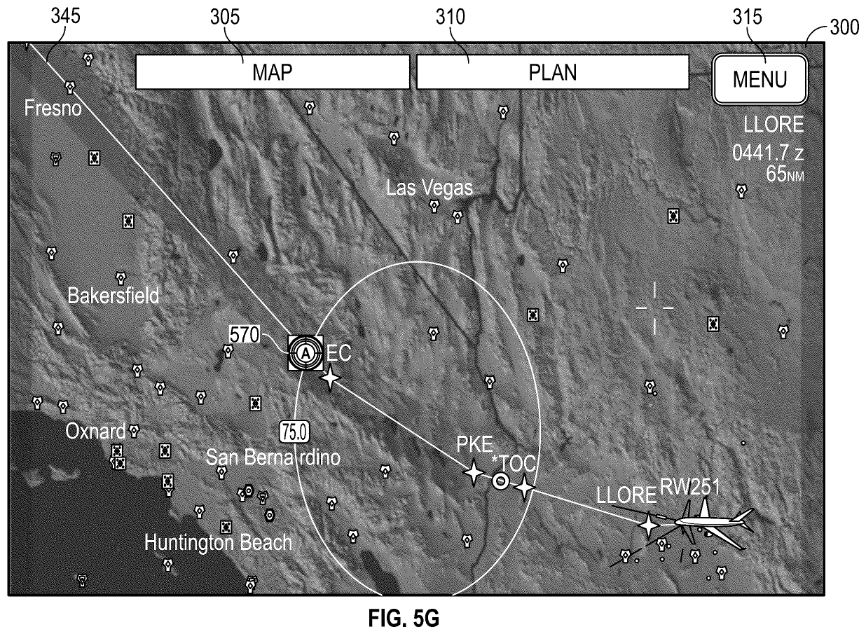

At sub-block 430, the FMS modifies attributes of the displayed flight parameter value to indicate that the flight parameter value is outside of a boundary limit associated with the flight parameter value. In one example shown in FIG. 5A, the FMS may modify attributes of the displayed flight parameter 340-16 (“Required Time of Arrival (RTA)”) associated with the selected position 350-2 when the predicted value of the flight parameter 340-16 is outside the boundary/buffet limit for the flight parameter 340-16. The FMS may modify attributes of the displayed flight parameter 340-16 to provide critical information on the predicted flight parameter.

At sub-block 440, the FMS modifies attributes of the displayed flight parameter value to indicate that the flight parameter value is at a boundary/buffet limit. For example, as shown in FIG. 5A, the FMS may modify attributes of the displayed flight parameter 340-3 (“HEAD WIND”) when the predicted value of the flight parameter 340-3 is at the boundary/buffer limit for the flight parameter 340-3. In certain aspects, the modified attributes of the displayed flight parameter value in block 440 is different from the modified attributes of the displayed flight parameter value in block 430.

At sub-block 450, the FMS modifies the ND to indicate the boundary limits. For example, as shown in FIG. 5B, if the user wants to know the boundary/buffet limit of the flight parameter 340-16, the user can touch at least one of the predicted value of flight parameter 340-16 or the flight parameter 340-16 on the ND 300 to trigger the display of popup window 510, which indicates the boundary limits for the flight parameter 340-16. In another example shown in FIG. 5C, if the user wants to know the boundary/buffet limit of the fight parameter 340-17, the user can touch at least one of the predicted value of flight parameter 340-17 or flight parameter 340-17 on the ND 300 to trigger the display of popup window 520, which indicates the boundary limits for the flight parameter 340-17. In certain aspects, the boundary limits may be displayed for a predetermined amount of time (e.g., three seconds or some other amount of time).

At sub-block 460, the FMS modifies the ND to indicate a first type of hazardous situation. The first type of hazardous situation may be a hazardous situation, which if not avoided, will result in serious impact to the aircraft (e.g., engine failure). In certain aspects, the ND may be modified with a first type of blinking symbol at the position of the flight plan associated with the first type of hazardous situation. As shown in FIG. 5D, for example, the symbol 560 may be shown to indicate the first type of hazardous situation. In certain aspects, if the user clicks or otherwise selects the symbol 560, the FMS may display a window (not shown) to show the predicted values of flight parameters associated with the first type of hazardous situation.

At sub-block 470, the FMS modifies the ND to indicate a second type of hazardous situation. The second type of hazardous situation may be a hazardous situation, which if not avoided, will result in minor or moderate impact to the aircraft (e.g., high head wind). In certain aspects, the ND may be modified with a second type of blinking symbol at the position of the flight plan. As shown in FIG. 5E, for example, the symbol 530 may be shown to indicate the second type of hazardous situation. In certain aspects, if the user clicks or otherwise selects the symbol 530, the FMS may display a window 540 to show the predicted values of flight parameters associated with the second type of hazardous situation, as shown in FIG. 5F.

At sub-block 480, the FMS modifies the ND to alert the user (e.g., raise attention). In certain aspects, the ND may be modified with a symbol to raise attention. As shown in FIG. 5G, for example, the symbol 570 may be shown to indicate the alert. In certain aspects, if the user clicks or otherwise selects the symbol 570, the FMS may display a window (not shown) to show the predicted values of flight parameters associated with the alert.

Advantageously, aspects described herein can significantly streamline the information/configuration setting, retrieval, and display process associated with providing flight information in cockpit navigation displays. As opposed to the pilot having to re-access multiple FMS pages to obtain critical flight information, aspects described herein enable the pilot to directly access predicted flight information on a visual display, such as ND 105. In this manner, aspects described herein can increase the locality of such critical information, reduce pilot effort, and reduce human error.

A further understanding of at least some of the aspects of the present disclosure is provided with reference to the following numbered Clauses, in which:

Clause 1: A computer-implemented method for dynamically presenting a visualization of flight information on a navigation display, the computer-implemented method comprising: presenting a window comprising a plurality of flight parameters on the navigation display; obtaining an indication of at least one first flight parameter selected from the plurality of flight parameters; and upon detecting a first position selected on the navigation display associated with a flight plan: predicting a first value of the at least one first flight parameter at the first position; and displaying the first value for the at least one first flight parameter on the navigation display.

Clause 2: The computer-implemented method of Clause 1, further comprising upon detecting a second position selected on the navigation display associated with the flight plan: predicting a second value of the at least one first flight parameter at the second position; and displaying the second value for the at least one first flight parameter on the navigation display, wherein the first position is different from the second position.

Clause 3: The computer-implemented method of any of Clauses 1 to 2, wherein predicting the first value of the at least one first flight parameter at the first position comprises performing at least one of an interpolation or an extrapolation based at least in part on a second value of the at least one first flight parameter at a second position on the flight plan, wherein the first position is different from the second position.

Clause 4: The computer-implemented method of any of Clauses 1 to 3, further comprising presenting a configuration option for selecting the plurality of flight parameters on the navigation display.

Clause 5: The computer-implemented method of Clause 4, wherein the window is presented in response to detecting that the configuration option has been selected.

Clause 6: The computer-implemented method of any of Clauses 1 to 5, wherein displaying the first value for the at least one first flight parameter comprises modifying at least one attribute of the first value to indicate that the first value satisfies a predetermined condition.

Clause 7: The computer-implemented method of Clause 6, wherein the predetermined condition comprises the first value being outside of a boundary limit associated with the at least one first flight parameter.

Clause 8: The computer-implemented method of Clause 7, further comprising displaying a pop-up window on the navigation display indicating the boundary limit in response to detecting user interaction with the navigation display.

Clause 9: The computer-implemented method of Clause 8, wherein the pop-up window is displayed for a predetermined amount of time.

Clause 10: The computer-implemented method of any of Clauses 6 and 8 to 9, wherein the predetermined condition comprises the first value being at a boundary limit associated with the at least one first flight parameter.

Clause 11: The computer-implemented method of any of Clauses 1 to 10, further comprising modifying the navigation display to indicate that the first value satisfies a predetermined condition.

Clause 12: The computer-implemented method of Clause 11, wherein the predetermined condition comprises the first value being associated with a hazardous situation in the flight plan.

Clause 13: A flight management system comprising: a navigation display configured to display information associated with a flight plan of an aircraft; a memory comprising executable instructions; and a processor in data communication with the memory and the navigation display and configured to execute the executable instructions to perform an operation comprising: presenting a window comprising a plurality of flight parameters on the navigation display; obtaining an indication of at least one first flight parameter selected from the plurality of flight parameters; and upon detecting a first position selected on the navigation display associated with the flight plan: predicting a first value of the at least one first flight parameter at the first position; and displaying the first value for the at least one first flight parameter on the navigation display.

Clause 14: The flight management system of Clause 13, the operation further comprising upon detecting a second position selected on the navigation display associated with the flight plan: predicting a second value of the at least one first flight parameter at the second position; and displaying the second value for the at least one first flight parameter on the navigation display, wherein the first position is different from the second position.

Clause 15: The flight management system of any of Clauses 13 to 14, wherein predicting the first value of the at least one first flight parameter at the first position comprises performing at least one of an interpolation or an extrapolation based at least in part on a second value of the at least one first flight parameter at a second position on the flight plan, wherein the first position is different from the second position.

Clause 16: The flight management system of any of Clauses 13 to 15, further comprising presenting a configuration option for selecting the plurality of flight parameters on the navigation display.

Clause 17: The flight management system of Clause 16, wherein the window is presented in response to detecting that the configuration option has been selected.

Clause 18: The flight management system of any of Clauses 13 to 17, wherein displaying the first value for the at least one first flight parameter comprises modifying at least one attribute of the first value to indicate that the first value satisfies a predetermined condition.

Clause 19: The flight management system of Clause 18, wherein the predetermined condition comprises the first value being outside of a boundary limit associated with the at least one first flight parameter or at the boundary limit associated with the at least one first flight parameter.

Clause 20: The flight management system of Clause 19, the operation further comprising displaying a pop-up window on the navigation display indicating the boundary limit in response to detecting user interaction with the navigation display.

Clause 21: The flight management system of Clause 20, wherein the pop-up window is displayed for a predetermined amount of time.

Clause 22: The flight management system of any of Clauses 18 and 20 to 21, wherein the predetermined condition comprises the first value being at a boundary limit associated with the at least one first flight parameter.

Clause 23: The flight management system of any of Clauses 13 to 22, the operation further comprising modifying the navigation display to indicate that the first value satisfies a predetermined condition.

Clause 24: The flight management system of claim 23, wherein the predetermined condition comprises the first value being associated with a hazardous situation in the flight plan.

Clause 25: A computer-readable storage medium having computer-readable program code embodied therewith for performing the computer-implemented method of any of Clauses 1 to 12.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A computer-implemented method for dynamically presenting a visualization of flight information on a navigation display, the computer-implemented method comprising:
presenting a window comprising a plurality of flight parameters on the navigation display;
obtaining an indication of at least one first flight parameter selected from the plurality of flight parameters; and
upon detecting a first position selected on the navigation display associated with a flight plan:
predicting a first value of the at least one first flight parameter at the first position; and
displaying the first value for the at least one first flight parameter on the navigation display.

2. The computer-implemented method of claim 1, further comprising upon detecting a second position selected on the navigation display associated with the flight plan:
predicting a second value of the at least one first flight parameter at the second position; and
displaying the second value for the at least one first flight parameter on the navigation display, wherein the first position is different from the second position.

3. The computer-implemented method of claim 1, wherein predicting the first value of the at least one first flight parameter at the first position comprises performing at least one of an interpolation or an extrapolation based at least in part on a second value of the at least one first flight parameter at a second position on the flight plan, wherein the first position is different from the second position.

4. The computer-implemented method of claim 1, further comprising presenting a configuration option for selecting the plurality of flight parameters on the navigation display.

5. The computer-implemented method of claim 4, wherein the window is presented in response to detecting that the configuration option has been selected.

6. The computer-implemented method of claim 1, wherein displaying the first value for the at least one first flight parameter comprises modifying at least one attribute of the first value to indicate that the first value satisfies a predetermined condition.

7. The computer-implemented method of claim 6, wherein the predetermined condition comprises the first value being outside of a boundary limit associated with the at least one first flight parameter.

8. The computer-implemented method of claim 7, further comprising displaying a pop-up window on the navigation display indicating the boundary limit in response to detecting user interaction with the navigation display.

9. The computer-implemented method of claim 8, wherein the pop-up window is displayed for a predetermined amount of time.

10. The computer-implemented method of claim 6, wherein the predetermined condition comprises the first value being at a boundary limit associated with the at least one first flight parameter.

11. The computer-implemented method of claim 1, further comprising modifying the navigation display to indicate that the first value satisfies a predetermined condition.

12. The computer-implemented method of claim 11, wherein the predetermined condition comprises the first value being associated with a hazardous situation in the flight plan.

13. A flight management system comprising:
a navigation display configured to display information associated with a flight plan of an aircraft;
a memory comprising executable instructions; and
a processor in data communication with the memory and the navigation display and configured to execute the executable instructions to perform an operation comprising:
presenting a window comprising a plurality of flight parameters on the navigation display;
obtaining an indication of at least one first flight parameter selected from the plurality of flight parameters; and
upon detecting a first position selected on the navigation display associated with the flight plan:
predicting a first value of the at least one first flight parameter at the first position; and
displaying the first value for the at least one first flight parameter on the navigation display.

14. The flight management system of claim 13, the operation further comprising upon detecting a second position selected on the navigation display associated with the flight plan:
predicting a second value of the at least one first flight parameter at the second position; and
displaying the second value for the at least one first flight parameter on the navigation display, wherein the first position is different from the second position.

15. The flight management system of claim 13, wherein predicting the first value of the at least one first flight parameter at the first position comprises performing at least one of an interpolation or an extrapolation based at least in part on a second value of the at least one first flight parameter at a second position on the flight plan, wherein the first position is different from the second position.

16. The flight management system of claim 13, further comprising presenting a configuration option for selecting the plurality of flight parameters on the navigation display.

17. The flight management system of claim 16, wherein the window is presented in response to detecting that the configuration option has been selected.

18. The flight management system of claim 13, wherein displaying the first value for the at least one first flight parameter comprises modifying at least one attribute of the first value to indicate that the first value satisfies a predetermined condition.

19. The flight management system of claim 18, wherein the predetermined condition comprises the first value being outside of a boundary limit associated with the at least one first flight parameter or at the boundary limit associated with the at least one first flight parameter.

20. A computer-readable storage medium having computer-readable program code embodied therewith for performing an operation for dynamically presenting a visualization of flight information on a navigation display, the operation comprising:
presenting a window comprising a plurality of flight parameters on the navigation display;
obtaining an indication of at least one first flight parameter selected from the plurality of flight parameters; and
upon detecting a first position selected on the navigation display associated with a flight plan:
predicting a first value of the at least one first flight parameter at the first position; and
displaying the first value for the at least one first flight parameter on the navigation display.
